(19) United States
(12) Patent Application Publication
(10) Pub. No.: US 2023/0351834 A1
(43) Pub. Date: Nov. 2, 2023

(54) CLOUD-BASED CONTACTLESS VENDING MACHINE

(71) Applicant: 6Success, Aliso Viejo, CA (US)

(72) Inventors: Bahar Ahmadi, Irvine, CA (US); Maryam Etminan, Irvine, CA (US)

(21) Appl. No.: 18/217,641

(22) Filed: Jul. 3, 2023

Related U.S. Application Data
(60) Provisional application No. 63/335,242, filed on Apr. 27, 2022.

(51) Int. Cl. G07F 9/00; G06K 19/06; G06K 7/14; G05B 19/042

(52) U.S. Cl. CPC G07F 9/002; G06K 19/06028; G06K 7/1413; G05B 19/042; G05B 2219/2645

(57) ABSTRACT

A vending machine having a smoothie mixing and dispensing assembly, a cooling assembly having a peltier element, and a pre-order holder having a carousel. A mobile device has an ordering app thereon. A server connects with the vending machine over a network, the server having memory for storing computer instructions and a processor for executing the computer instructions, the computer instructions including instructions for implementing a meal planning application with an artificial intelligence module for planning meals. The mobile device communicates an order to the vending machine to activate the smoothie mixing and dispensing assembly to prepare a smoothie for storing in the pre-order holder.

### CROSS REFERENCE TO RELATED APPLICATION

This application claims the benefit under 35 U.S.C. § 119(e) of U.S. Provisional Application No. 63/358,274 entitled “CLOUD-BASED CONTACTLESS VENDING MACHINE” filed Jul. 5, 2022, which is incorporated herein by reference.

### BACKGROUND

The preparation and dispensation of food and beverages is a predominantly human-mediated process. Preparing meals, snacks, beverages, etc. is a time-consuming process subject to imprecision due to variations introduced by the human preparer (e.g. measurement inaccuracy, imprecise heating, timing of operations such as heating, marinating, mixing, blending, etc.). These limitations can be overcome with the limited degree of automation or assistance that can provided through conventional coffee/espresso machines, vending machines, smoothie machines, and other similar machines.

Indeed, vending machines and smoothie machines are well known. Unfortunately, it is difficult to combine these types of machines because smoothies must be in constant mix to maintain the desired consistency of the suspension. Further, it is difficult to produce multiple flavors of smoothies.

Accordingly, it would be of great advantage to provide systems and techniques for combining the advantages of vending machines and smoothie machines in a manner that provides greater availability, precision and accuracy to the process, and avoid safety concerns, all the while conserving space and cost of a system capable of performing a wide variety of tasks useful in the context of smoothie preparation and dispensation.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a vending machine system includes a vending machine having a smoothie mixing and dispensing assembly, a cooling assembly having a peltier element, and a pre-order holder having a carousel. A mobile device has an ordering app thereon. A server connects with the vending machine over a network, the server having memory for storing computer instructions and a processor for executing the computer instructions, the computer instructions including instructions for implementing a meal planning application with an artificial intelligence module for planning meals. The mobile device communicates an order to the vending machine to activate the smoothie mixing and dispensing assembly to prepare a smoothie for storing in the pre-order holder.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a block diagram of a cloud-based vending machine system in accordance with the subject disclosure.

FIG. 2 is a perspective view of a vending machine that is part of the cloud-based vending machine system in FIG. 1.

FIG. 3 is a side view of the vending machine shown in FIG. 2.

FIG. 4 is a front view of the vending machine shown in FIG. 2.

FIG. 5 is a top view of the vending machine shown in FIG. 2.

FIG. 6 is a fragmentary perspective view of a carousel device within the vending machine shown in FIG. 2.

FIG. 7 is a fragmentary perspective view of an automated straw dispenser within the vending machine shown in FIG. 2.

FIG. 8 is an exemplary process in accordance with the subject disclosure.

FIG. 9 is an exemplary mobile device in accordance with the subject disclosure.

FIG. 10 is an exemplary computing device in accordance with the subject disclosure.

FIG. 11 is an exemplary cloud computing system in accordance with the subject disclosure.

### DETAILED DESCRIPTION

The subject disclosure is directed to a cloud-based contactless vending machine and, more particularly, to a system that includes a smoothie vending machine that can be cooled by a cooling system that includes a peltier element and a meal planning application that includes an artificial intelligence module that can plan meals. The system can include other improvements, such as an alarm generator that activates to produce an alarm when the vending machine has a low inventory of ingredients, a juice press for producing cold pressed juice, an automated straw dispenser for inserting straws into a smoothie, and a smoothie preserver for holding smoothies that have been pre-ordered and canceled.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

References to an “app”, an “application”, and a “software application” shall refer to a computer program or group of programs designed for end users. The terms shall encompass standalone applications, thin client applications, thick client applications, web-based applications, such as a browser, and other similar applications.

References to “Internet of Things” or “IoT” shall refer to smart systems and/or devices comprised of physical objects that are embedded with sensors, processing ability, software, and other technologies, and that connect and exchange data with other devices and systems over the Internet or other communications networks. The systems can represent a convergence of multiple technologies, including ubiquitous computing, commodity sensors, increasingly powerful embedded systems, and machine learning.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The subject disclosure is directed to a cloud-based contactless vending machine system that utilizes IoT technology to control the operations thereof. The system can utilize WAN IoT protocol to provide the ability to order smoothies and manage inventory.

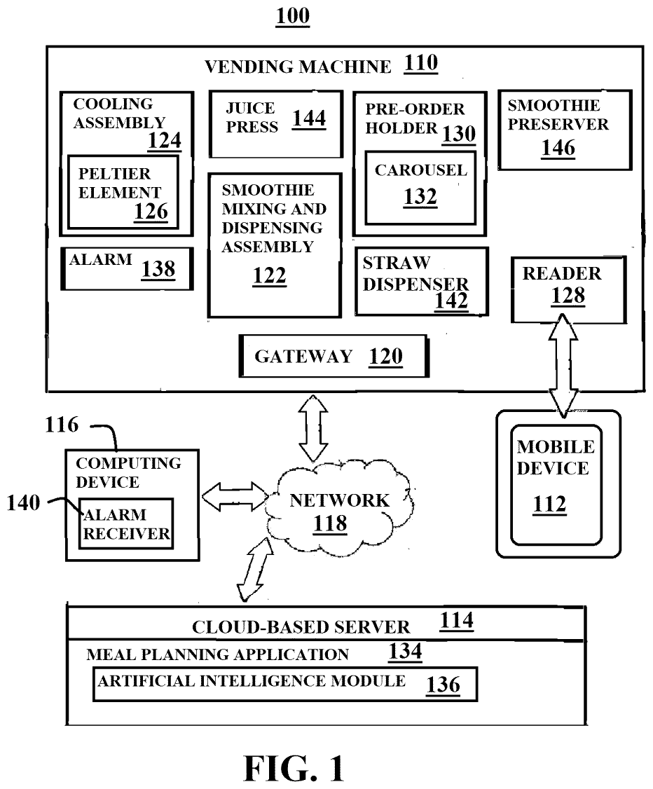

Referring to FIG. 1, a vending machine system, generally designated by the numeral 100, is shown. The vending machine system 100 includes a vending machine 110, a mobile device 112, a server 114, and computing device 116. The vending machine 110 connects to the server 114 and/or to the computing device 116 over a network 118 through a gateway 120. In this exemplary embodiment, the gateway 120 can be an IOT gateway. The mobile device 112 and/or the computing device 116 can be any type of computing device, including a smartphone, a handheld computer, a tablet, a PC, or any other client device.

The vending machine 110 includes a smoothie mixing and dispensing assembly 122 that performs many of the functions to prepare smoothies that are described in co-pending U.S. Provisional Patent Application No. 63/335,242, filed Apr. 27, 2022. The vending machine 110 is cooled by a cooling system 124 that includes a peltier element 126.

The vending machine 110 can be activated by the mobile device 112 generating a code that can be read by a reader 128 connected to the vending machine 110. In this exemplary embodiment, the mobile device 112 generates a barcode for display thereon. The reader 128 can read the barcode to activate the vending machine 110 to make the smoothie.

The vending machine 110 can include a pre-order holder 130, such as a pre-order box for keeping pre-ordered smoothies cool. The pre-order holder 130 can include a carousel device 132 for holding the smoothies and for moving the smoothies.

As shown in FIG. 1, the cloud server 114 can include a meal planning application 134 that includes an Artificial Intelligence (AI) module 136 that can plan meals based upon data collected by the system 100 and/or by data input into the system 100. The module 136 can set objectives, such as helping to decrease cholesterol, to increase ferric content, to lose weight, and/or to achieve other objectives.

The AI module 136 can have a trained AI meal planning model. The AI module 136 can utilize an AI application and/or a machine learning application. The AI module 136 can emulate human thought and perform tasks in a real-world environment, namely identifying patterns, making decisions, and improving operations through experience and data. The AI module 136 can use deep learning, neural networks, computer vision, and natural language processing.

The vending machine 110 can include an alarm generator 138 that can generate an alarm to send to the operator and/or owner of the vending machine 110 through the network 118 when the smoothie ingredients or supplies are low. The operator and/or owner can receive the alarm on the computing device 116 on an alarm receiver 140. The alarm receiver 140 can be an application, an app, or similar device.

The vending machine 110 can include an automated straw dispenser 142 that can insert straws into smoothie containing vessels automatically. The vending machine 110 can include a juice press 144 configured to provide cold pressed juice.

The vending machine 110 can include a smoothie preserver 146. The smoothie preserver 146 can be a box that stores smoothies from canceled orders that can be offered to customers freely.

Network 118 can be implemented by any type of network or combination of networks including, without limitation: a wide area network (WAN) such as the Internet, a local area network (LAN), a Peer-to-Peer (P2P) network, a telephone network, a private network, a public network, a packet network, a circuit-switched network, a wired network, and/or a wireless network. Computer systems and/or computing devices can communicate via network 116 using various communication protocols (e.g., Internet communication protocols, WAN communication protocols, LAN communications protocols, P2P protocols, telephony protocols, and/or other network communication protocols), various authentication protocols, and/or various data types (web-based data types, audio data types, video data types, image data types, messaging data types, signaling data types, and/or other data types).

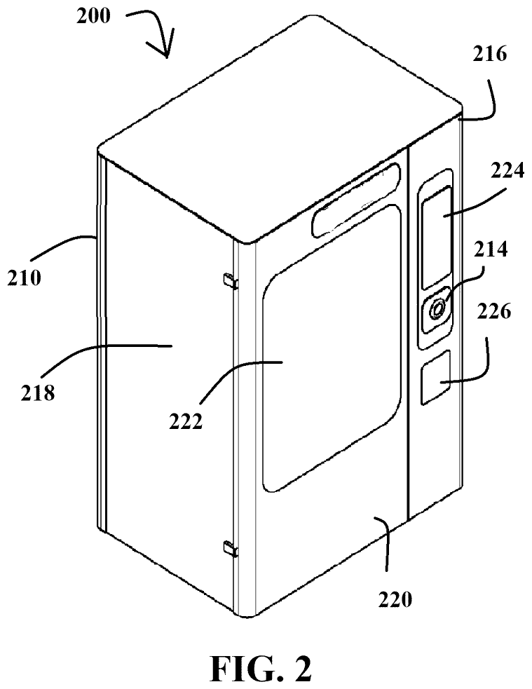

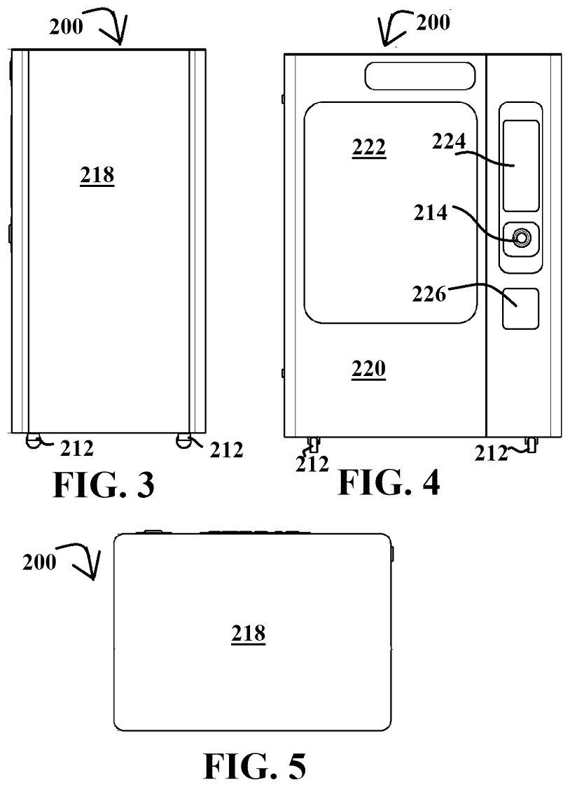

Referring now to FIGS. 2-5, a vending machine, generally designated with the numeral 200, is shown. The vending machine 200 is essentially identical to the vending machine 110 shown in FIG. 1. The vending machine 200 has an essentially cuboid-shaped body 210 that is mounted on wheels 212.

The vending machine 200 includes a bar code reader 214 on its exterior shell 216. The bar code reader 214 is essentially identical to the bar code reader 128 shown in FIG. 1. The exterior shell 216 includes housing 218 with a door 220 pivotally connected thereto.

The door 220 includes a glass panel 222 that can be used to display the product and/or information about the product. The door 220 also includes a screen 224 connected to a display device for displaying information about the product, advertising material, messages for customers or other related information and/or indicia. The product can be conveyed through a slot 226 in the door 220.

The door 220 can be opened to provide access to the interior of the vending machine 200. The interior of the vending machine 200 can include the gateway 120, the smoothie mixing and dispensing assembly 122, the cooling system 124, the peltier element 126, the pre-order holder 130, the carousel device 132, the alarm generator 138, the automated straw dispenser 142, the juice press 144, and the smoothie preserver 146.

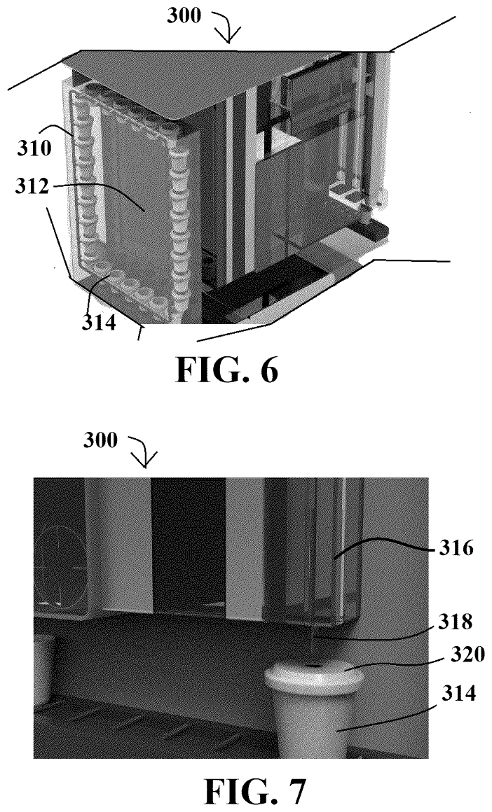

Referring to now to FIGS. 6-7, certain components within the interior, generally designated by the numeral 300, of a vending machine are shown. In this exemplary embodiment, the vending machine can be the vending machine 110 shown in FIG. 1 and/or the vending machine 200 shown in FIGS. 2-5.

As shown in FIG. 6, the interior 300 includes a pre-order holder 310 and a carousel device 312 for holding smoothies 314 and for moving the smoothies 314. The pre-order holder 310 and the carousel device 312 are essentially identical to the pre-order holder 310 and the carousel device 132 shown in FIG. 1.

As shown in FIG. 7, the interior 300 includes an automatic straw dispenser 316. The straw dispenser 316 has the ability to insert a straw 318 into one of the smoothies 314 through a lid 320. The automatic straw dispenser 200 is essentially identical to the straw dispenser 142 shown in FIG. 1.

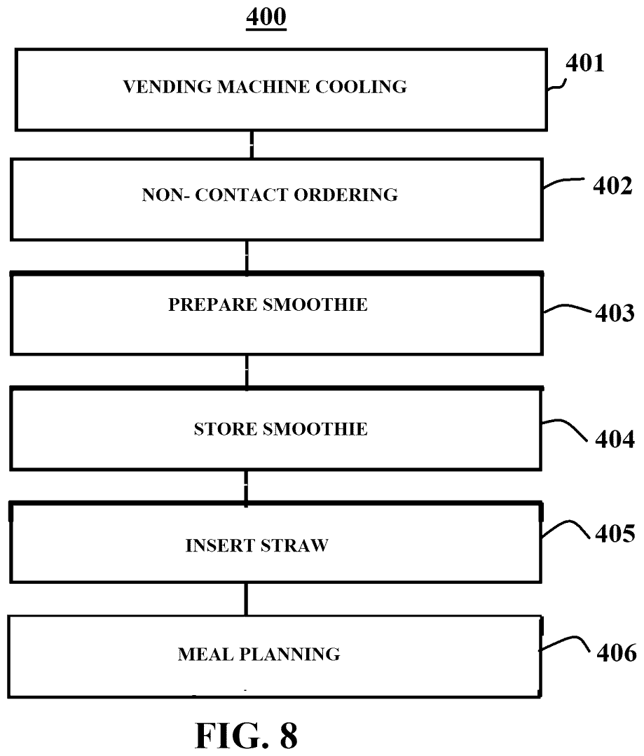

Referring to FIG. 8 with continuing reference to the foregoing figures, an exemplary process, generally designated by the numeral 400, for preparing a smoothie is shown. The process 400 can be a performed within the system 100 shown in FIG. 1.

At 401, a vending machine is cooled with a cooling assembly that include a peltier element. In this exemplary embodiment, the vending machine can be the vending machine 110 shown in FIG. 1. The cooling assembly and the peltier element can be the cooling assembly 124 and the peltier element 126 shown in FIG. 1.

At 402, the vending machine receives an order from a mobile app. The ordering is non-contact. In this exemplary embodiment, the mobile app can reside on the mobile device 112 shown in FIG. 1.

At 403, the vending machine prepares the smoothie with a mixing and dispensing assembly. In this exemplary embodiment, the mixing and dispensing assembly can be the mixing and dispensing assembly 122 shown in FIG. 1.

At 404, the smoothie is stored in the vending machine in a vessel. In this exemplary embodiment, the vessel can be stored in the pre-order holder 130 or the smoothie preserver 146 shown in FIG. 1

At 405, a straw is inserted into the vessel. In this exemplary embodiment, the straw can be inserted, automatically, with the straw inserter 142 shown in FIG. 1. Then, the vessel, the smoothie, and the straw can be dispensed from the vending machine.

At 406, a cloud server connects with the vending machine over a network to obtain data about the order, so that a meal-planning application residing on the cloud server uses the data to prepare a meal plan using artificial intelligence. In this exemplary embodiment, the meal plan can be prepared with the meal planning application 134 using the AI module 136 shown in FIG. 1.

### Exemplary Mobile Device

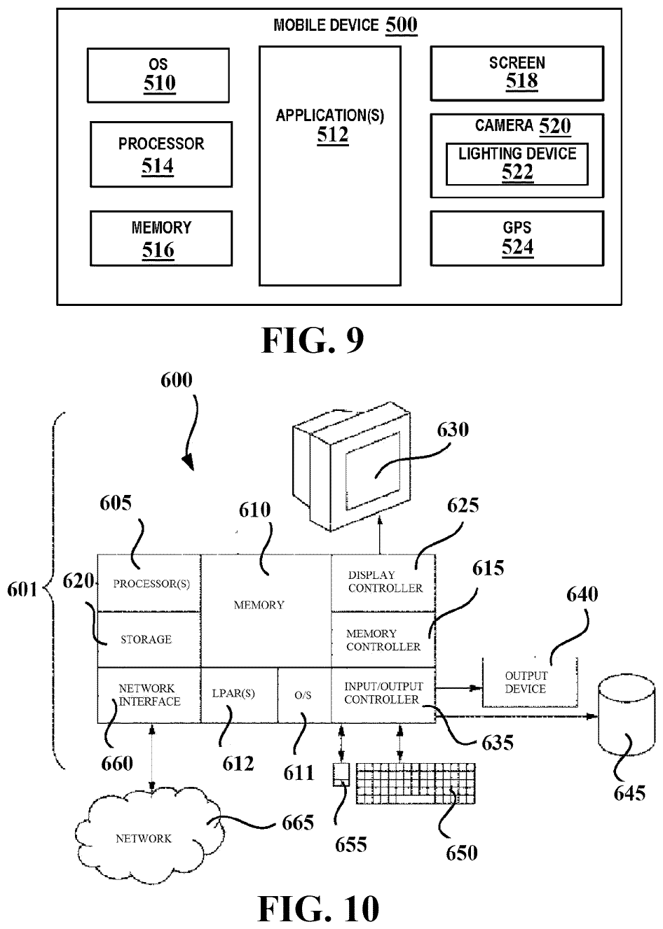

Referring now to FIG. 9 with continuing reference to the foregoing figures, an exemplary mobile device, generally designated by the numeral 500, is shown. The mobile device 500 can be the mobile device 112 shown in FIG. 1.

Mobile device 500 can include operating system 510 and various types of mobile application(s) 512. In some implementations, mobile application(s) 512 can include one or more client application(s) and/or components of a client application. In this exemplary embodiment, one of the mobile applications 512 can be an app that allows a user to select various smoothie ingredients, order a smoothie, pay for the smoothie, and generate a barcode to activate a vending machine, like the vending machine 110 shown in FIG. 1.

Mobile device 500 can include processor 514 for performing tasks such as signal coding, data processing, input/output processing, power control, and/or other functions, and memory 516 that can be used for storing data and/or code for running operating system 510 and/or mobile application(s) 512. Example data can include web pages, text, images, sound files, video data, or other data to be sent to and/or received from one or more network servers or other devices via one or more wired and/or wireless networks, such as the server 114 shown in FIG. 1.

Mobile device 500 can include screen 518 and camera 520. The camera 520 can include a lighting device 522. Operating system 510, application(s) 512, processor 514, and/or memory 516 can cooperate to utilize the camera 520 and the lighting device 522 to obtain images. The screen 518 can display a code, such as a barcode

The mobile device 500 can configure and implement a global positioning system (GPS) 524. The operating system 510 and/or the application(s) 512 can communicate with the GPS 524 to obtain location data. The GPS 524 can be used by the app 512 to help a user identify a nearby vending machine.

### Exemplary Computing Devices

Referring now to FIG. 10 with continuing reference to the forgoing figures, an exemplary computing system, generally designated by the numeral 600, for use by the system 100 shown in FIG. 1. The system 600 can be used to implement the cloud-based server 114 shown in FIG. 1.

The methods described herein can be implemented in hardware, software (e.g., firmware), or a combination thereof. In an exemplary embodiment, the methods described herein are implemented in hardware as part of the microprocessor of a special or general-purpose digital computer, such as a personal computer, workstation, minicomputer, or mainframe computer. The system 600 therefore can include general-purpose computer or mainframe 601 capable of running multiple instances of an O/S simultaneously.

In an exemplary embodiment, in terms of hardware architecture, as shown in FIG. 10, the computer 601 includes one or more processors 605, memory 610 coupled to a memory controller 615, and one or more input and/or output (I/O) devices 640, 645 (or peripherals) that are communicatively coupled via a local input/output controller 635. The input/output controller 635 can be, for example but not limited to, one or more buses or other wired or wireless connections, as is known in the art. The input/output controller 635 can have additional elements, which are omitted for simplicity, such as controllers, buffers (caches), drivers, repeaters, and receivers, to enable communications. Further, the local interface can include address, control, and/or data connections to enable appropriate communications among the aforementioned components. The input/output controller 635 can include a plurality of sub-channels configured to access the output devices 640 and 645. The sub-channels can include fiber-optic communications ports.

The processor 605 is a hardware device for executing software, particularly that stored in storage 620, such as cache storage, or memory 610. The processor 605 can be any custom made or commercially available processor, a central processing unit (CPU), an auxiliary processor among several processors associated with the computer 601, a semiconductor based microprocessor (in the form of a microchip or chip set), a macroprocessor, or generally any device for executing instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 can incorporate electronic, magnetic, optical, and/or other types of storage media. Note that the memory 610 can have a distributed architecture, where various components are situated remote from one another, but can be accessed by the processor 605.

The instructions in memory 610 can include one or more separate programs, each of which comprises an ordered listing of executable instructions for implementing logical functions. In the example of FIG. 10, the instructions in the memory 610 a suitable operating system (OS) 611. The operating system 611 essentially controls the execution of other computer programs and provides scheduling, input-output control, file and data management, memory management, and communication control and related services. In accordance with one or more embodiments, the memory 610 and/or an I/O device 645 can be used to store the file attribute tables 630.

The memory 610 can include multiple logical partitions (LPARs) 612, each running an instance of an operating system. The LPARs 612 can be managed by a hypervisor, which can be a program stored in memory 610 and executed by the processor 605.

In an exemplary embodiment, a conventional keyboard 650 and mouse 655 can be coupled to the input/output controller 635. Other output devices such as the I/O devices 640, 645 can include input devices, for example but not limited to a printer, a scanner, microphone, and the like. Finally, the I/O devices 640, 645 can further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 600 can further include a display controller 625 coupled to a display 630. In an exemplary embodiment, the system 600 can further include a network interface 660 for coupling to a network 665. The network 665 can be an IP-based network for communication between the computer 601 and any external server, client and the like via a broadband connection. The network 665 transmits and receives data between the computer 601 and external systems.

If the computer 601 is a PC, workstation, intelligent device or the like, the instructions in the memory 610 can further include a basic input output system (BIOS) (omitted for simplicity). The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute instructions stored within the memory 610, to communicate data to and from the memory 610, and to generally control operations of the computer 601 pursuant to the instructions. In accordance with one or more embodiments described herein, the computer 601 can implement and/or perform the disclosed subject matter.

### Exemplary Cloud Computer System

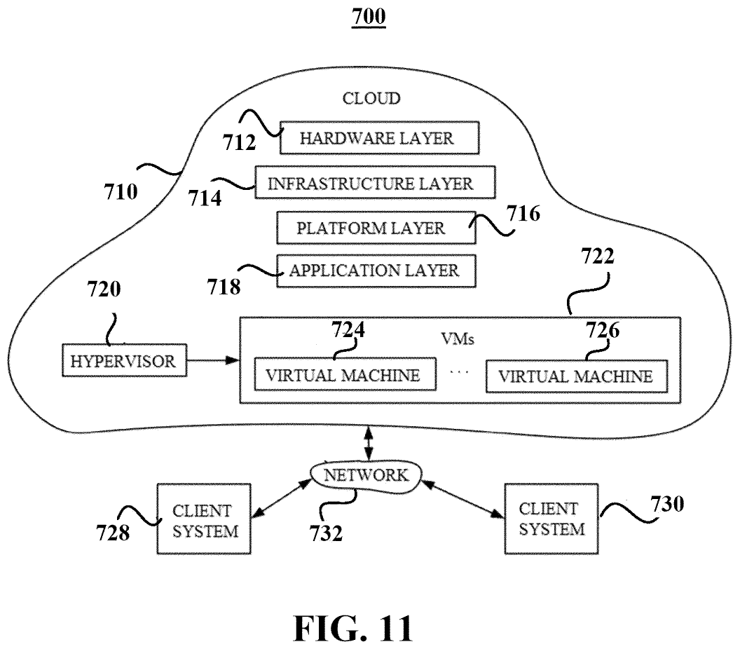

Referring now to FIG. 11 with continuing reference to the forgoing figures, exemplary cloud architecture, generally designated by the numeral 700, for use by a vending machine system, such as vending machine system 100 shown in FIG. 1. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 700 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

As shown in FIG. 11, the cloud architecture 700 includes a cloud 710. The cloud 710 (or each of the different premises on the cloud 710) can include a hardware layer 712, an infrastructure layer 714, a platform layer 716, and an application layer 718.

A hypervisor 720 can illustratively manage or supervise a set of virtual machines 722 that can include a plurality of different, independent, virtual machines 724-726. Each virtual machine can illustratively be an isolated software container that has an operating system and an application inside it. It is illustratively decoupled from its host server by hypervisor 720. In addition, hypervisor 720 can spin up additional virtual machines or close virtual machines, based upon workload or other processing criteria.

A plurality of different client systems 728-730 (which can be end user systems or administrator systems, or both) can illustratively access cloud 710 over a network 732. Depending upon the type of service being used by each of the client systems 728-730, cloud 710 may provide different levels of service. In one example, the users of the different client systems are provided access to application software and databases. The cloud service then manages the infrastructure and platforms that run the application. This can be referred to as software as a service (or SaaS). The software providers operate application software in application layer 712 and end users access the software through the different client systems 728-730.

The cloud provider can also use platform layer 716 to provide a platform as a service (PaaS). This involves an operating system, programming language execution environment, database and webserver being provided to the client systems 728-730, as a service, from the cloud provider. Application developers then normally develop and run software applications on that cloud platform and the cloud provider manages the underlying hardware and infrastructure and software layers.

The cloud provider can also use infrastructure layer 714 to provide infrastructure as a service (IaaS). In such a service, physical or virtual machines and other resources are provided by the cloud provider, as a service. These resources are provided, on-demand, by the IaaS cloud provider, from large pools installed in data centers. In order to deploy applications, the cloud users that use IaaS install operating-system images and application software on the cloud infrastructure 700.

It should also be noted that architecture 700, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

Further, it should be understood that some embodiments shown in FIGS. 1-5 can be implemented through cloud infrastructure, such as the cloud infrastructure 700 shown in FIG. 11, and/or through a conventional computer system, such as the computer system 600 shown in FIG. 10. In other embodiments, computer systems and/or computing devices can be implemented within a hybrid cloud environment that includes cloud infrastructure, such as cloud infrastructure 700 shown in FIG. 11, and one or more computer systems, such computer system 600 shown in FIG. 10.

### Supported Features and Embodiments

The detailed description provided above in connection with the appended drawings explicitly describes and supports various features of a cloud-based contactless vending machine. By way of illustration and not limitation, supported embodiments include a vending machine system comprising: a vending machine having a smoothie mixing and dispensing assembly, a cooling assembly having a peltier element, and a pre-order holder having a carousel; a mobile device having an ordering app thereon; and a server connecting with the vending machine over a network, the server having memory for storing computer instructions and a processor for executing the computer instructions, the computer instructions including instructions for implementing a meal planning application with an artificial intelligence module for planning meals; wherein the mobile device communicates an order to the vending machine to activate the smoothie mixing and dispensing assembly to prepare a smoothie for storing in the pre-order holder.

Supported embodiments include the foregoing vending machine, wherein the vending machine includes a reader and the mobile device app generates a code to communicate to the reader to activate the smoothie mixing and dispensing assembly.

Supported embodiments include any of the foregoing vending machines, wherein the mobile device app generates a barcode that can be read by the reader.

Supported embodiments include any of the foregoing vending machines, wherein the meal planning application implement the artificial intelligence module to plan a meal with an objective selected from the group consisting of lowering cholesterol, increasing ferric content, and losing weight.

Supported embodiments include any of the foregoing vending machines, further comprising: a computing device connected to the network; wherein the vending machine includes an alarm generator that activates to produce an alarm when the vending machine has a low inventory of ingredients; and wherein the vending machine sends the alarm to the computing device over the network.

Supported embodiments include any of the foregoing vending machines, wherein the vending machine includes a juice press.

Supported embodiments include any of the foregoing vending machines, wherein the vending machine includes an automated straw dispenser for inserting straws into a smoothie.

Supported embodiments include any of the foregoing vending machines, wherein the vending machine includes a smoothie preserver for holding smoothies that have been pre-ordered and canceled.

Supported embodiments include a method for providing a smoothie from a vending machine, the method comprising: cooling the vending machine with a cooling assembly that include a peltier element; receiving, with the vending machine, an order from a mobile app residing on a mobile device; mixing ingredients within a mixing and dispensing assembly on the vending machine to form the smoothie; storing the smoothie in a vessel within the vending machine; inserting a straw into the vessel; and dispensing the vessel, the smoothie, and the straw from the vending machine.

Supported embodiments include the foregoing method, further comprising: receiving the order from the mobile app through a non-contact connection.

Supported embodiments include any of the foregoing methods, further comprising: pouring the smoothie into a vessel within the vending machine.

Supported embodiments include any of the foregoing methods, wherein the vessel is stored with at least one of a pre-order holder and a smoothie preserver within the vending machine.

Supported embodiments include any of the foregoing methods, further comprising: connecting the vending machine to a cloud server over a network to send data about the order to a meal planning application for analyzing the order residing on the cloud server.

Supported embodiments include any of the foregoing methods, further comprising: preparing a meal plan based upon the order.

Supported embodiments include any of the foregoing methods, wherein the meal planning application implements an artificial intelligence module to plan a meal with an objective selected from the group consisting of lowering cholesterol, increasing ferric content, and losing weight.

Supported embodiments include any of the foregoing methods, wherein the vending machine includes a reader further comprising: generating, with the mobile app, a code to communicate to the reader to activate the smoothie mixing and dispensing assembly.

Supported embodiments include any of the foregoing methods, further comprising: generating, with the mobile app, a barcode that can be read by the reader.

Supported embodiments include any of the foregoing methods, further comprising: connecting a computing device to the vending machine over a network; producing, with an alarm generator, an alarm when the vending machine has a low inventory of ingredients; and sending, from the vending machine, the alarm to the computing device over the network.

Supported embodiments include any of the foregoing methods, wherein the vending machine includes a juice press.

Supported embodiments include any of the foregoing methods, wherein the vending machine includes a smoothie preserver for holding smoothies that have been pre-ordered and canceled.

Supported embodiments include a device, an apparatus, a computer-readable storage medium, a computer program product and/or means for implementing any of the foregoing systems, methods, or portions thereof.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A vending machine system comprising:
a vending machine having a smoothie mixing and dispensing assembly, a cooling assembly having a peltier element, and a pre-order holder having a carousel;
a mobile device having an ordering app thereon; and
a server connecting with the vending machine over a network, the server having memory for storing computer instructions and a processor for executing the computer instructions, the computer instructions including instructions for implementing a meal planning application with an artificial intelligence module for planning meals;
wherein the mobile device communicates an order to the vending machine to activate the smoothie mixing and dispensing assembly to prepare a smoothie for storing in the pre-order holder.

2. The vending machine system of claim 1, wherein the vending machine includes a reader and the mobile device app generates a code to communicate to the reader to activate the smoothie mixing and dispensing assembly.

3. The vending machine system of claim 2, wherein the mobile device app generates a barcode that can be read by the reader.

4. The vending machine system of claim 1, wherein the meal planning application implements the artificial intelligence module to plan a meal with an objective selected from the group consisting of lowering cholesterol, increasing ferric content, and losing weight.

5. The vending machine system of claim 1, further comprising:
a computing device connected to the network;
wherein the vending machine includes an alarm generator that activates to produce an alarm when the vending machine has a low inventory of ingredients; and
wherein the vending machine sends the alarm to the computing device over the network.

6. The vending machine system of claim 1, wherein the vending machine includes a juice press.

7. The vending machine system of claim 1, wherein the vending machine includes an automated straw dispenser for inserting straws into a smoothie.

8. The vending machine system of claim 1, wherein the vending machine includes a smoothie preserver for holding smoothies that have been pre-ordered and canceled.

9. A method for providing a smoothie from a vending machine, the method comprising:
cooling the vending machine with a cooling assembly that include a peltier element;
receiving, with the vending machine, an order from a mobile app residing on a mobile device;
mixing ingredients within a mixing and dispensing assembly on the vending machine to form the smoothie;
storing the smoothie in a vessel within the vending machine;
inserting a straw into the vessel; and
dispensing the vessel, the smoothie, and the straw from the vending machine.

10. The method of claim 9, further comprising:
receiving the order from the mobile app through a non-contact connection.

11. The method of claim 9, further comprising:
pouring the smoothie into a vessel within the vending machine.

12. The method of claim 9, wherein the vessel is stored with at least one of a pre-order holder and a smoothie preserver within the vending machine.

13. The method of claim 9, further comprising:
connecting the vending machine to a cloud server over a network to send data about the order to a meal planning application for analyzing the order residing on the cloud server.

14. The method of claim 13, further comprising:
preparing a meal plan based upon the order.

15. The method of claim 14, wherein the meal planning application implements an artificial intelligence module to plan a meal with an objective selected from the group consisting of lowering cholesterol, increasing ferric content, and losing weight.

16. The method of claim 9, wherein the vending machine includes a reader further comprising:
generating, with the mobile app, a code to communicate to the reader to activate the smoothie mixing and dispensing assembly.

17. The method of claim 15, further comprising:
generating, with the mobile app, a barcode that can be read by the reader.

18. The method of claim 9, further comprising:
connecting a computing device to the vending machine over a network;
producing, with an alarm generator, an alarm when the vending machine has a low inventory of ingredients; and
sending, from the vending machine, the alarm to the computing device over the network.

19. The method of claim 9, wherein the vending machine includes a juice press.

20. The method of claim 9, wherein the vending machine includes a smoothie preserver for holding smoothies that have been pre-ordered and canceled.
